(19) United States
(12) Patent Application Publication
(10) Pub. No.: US 2005/0046207 A1
(43) Pub. Date: Mar. 3, 2005

(54) Vehicle impact attenuation device

(76) Inventor: Michael Rossmann, Eurasburg (DE)

Correspondence Address: SUGHRUE MION, PLLC, 2100 PENNSYLVANIA AVENUE, N.W., SUITE 800, WASHINGTON, DC, 20037, US

(21) Appl. No.: 10/913,470

(22) Filed: Aug. 9, 2004

(30) Foreign Application Priority Data
Aug. 11, 2003 (DE) 103 36 713.6

(51) Int. Cl. B60R 19/34

(52) U.S. Cl. 293/133

(57) ABSTRACT

The vehicle impact attenuator comprises at least two impact absorber bodies for transforming impact energy which acts along a central impact axis, into deformation energy. The bodies are arranged in pairs, and the bodies of each pair are located on either side of a central axis of the device, and are mechanically interconnected in such a way that the deformation of one of these bodies due to a crashing vehicle results in a deformation also of the other absorber body, induced by said mechanical interconnection.

### BACKGROUND OF THE INVENTION

The invention refers to a vehicle impact attenuation device according to the preamble of claim 1. Such an attenuator is known for example from U.S. Pat. No. 4,711,481.

Vehicle impact attenuation devices are intended to improve security of the vehicle traffic by becoming deformed in a controlled manner when a vehicle hurts the device, thus destroying kinetic energy of the vehicle. There exist stationary vehicle impact attenuation devices, which are anchored at the ground, for example in front of a traffic divider, at the end of lateral crash barriers or in front of bridge piers, and mobile devices mounted at the rear end of heavy trucks for protecting temporary road works close to busy traffic. Such devices cannot avoid accidents but they can reduce the consequences thereof.

In general, vehicle impact attenuation devices comprise a plurality of absorber bodies disposed in rows and columns, the bodies being deformed by an impact and thus transforming kinetic into deformation energy. The essential requirement is a defined and continuous speed reduction until standstill. For passagers having closed their seat belts heavy injuries are rare if the slow-down forces remain below 10 g. This value corresponds approximately to an impact speed of 70 km/h and an effective device length of 2.2 m. The total slow-down phase terminates after 0.23 seconds.

A vehicle impact attenuation device should be able to efficiently slow down vehicles of various weights, of various speeds and impacting under various angles. This requirement however is only fulfilled if the length of the device is oversized. For mobile devices such a length is not practicable, for stationary devices this is at least an eye-sore and finally also restricted.

In the case of the impact attenuation device according to the cited US patent all the absorber bodies are affected uniformly only by a central and straight impact which allows to realise the calculated speed reduction rate. However, this ideal situation is present only in less than 10% of accidents.

If the impact is excentric and/or inclined, an other important disadvantage appears besides the fact that the deceleration rate is less high: The absorber bodies not directly affected by the impact maintain largely their original shape while the affected bodies are heavily deformed. As a result, the impact plate of the device inclines with respect of the central impact axis and tends to one side. The impacting vehicle thus is then rebounded in lateral direction and in an uncontrollable manner. It may then happen that it is catapulted into the traffic running nearby. The impact attenuation device can then be compared to an accordion which is deformed if an eccentric pressure is applied.

### OBJECT OF THE INVENTION

The invention aims to propose a vehicle impact attenuation device which avoids the consequences cited above of an eccentric and/or inclined impact.

This aim is achieved according to the main aspect of this invention, by a vehicle impact attenuator comprising at least two impact absorber bodies for transforming impact energy, which acts along a central impact axis, into deformation energy, the bodies being arranged in pairs, the bodies of each pair being located on either side of a central axis of the device, and being mechanically interconnected in such a way that the deformation of one of these bodies due to a crashing vehicle results in a deformation also of the other absorber body, induced by said mechanical interconnection.

For preferred embodiments of the invention reference is made to the secondary claims.

The invention will now be described in more detail with reference to the attached drawings. For identical elements identical reference numbers are used in all drawings.

### LIST OF DRAWINGS

FIG. 1 shows schematically and in a perspective view a vehicle impact attenuation device according to the invention comprising two absorber bodies.

FIG. 2 shows in an enlarged view one such body.

FIG. 3 shows schematically the vehicle impact attenuator device of FIG. 1 after a frontal and central impact.

FIG. 4 shows the same device after an eccentric impact affecting only one of the two absorber bodies.

FIG. 5 shows a top view of a vehicle impact attenuation device according to the invention having several rows of absorber bodies.

### DETAILED DESCRIPTION OF PREFERRED EMBODIMENTS

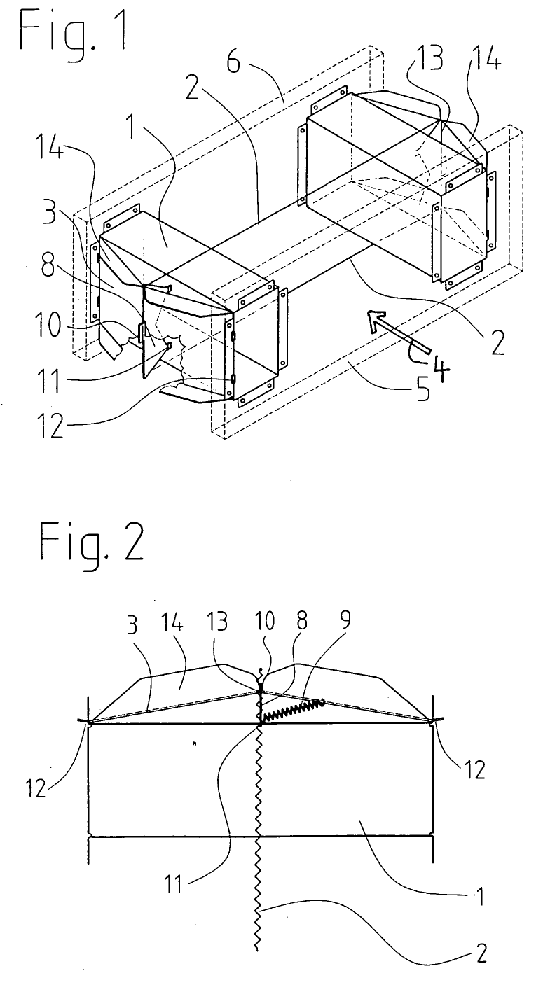

FIG. 1 shows two absorber bodies 1 disposed symmetrically on either side of a central axis and consisting each of a rigid metal box. Both boxes are fastened by screws, rivets or similar means to an impact plate 5 and a rear plate 6 (shown in interrupted lines). The rear plate is secured to the rear end of a heavy truck or to the ground. If the device, as it is common and shown in FIG. 5, comprises several rows of absorber bodies, the individual bodies are fixed by screwing or soldering to intermediate plates. In case of an impact the boxes are deformed and the distance between the impact plate and the rear plate and between the intermediate plates is reduced. The deformation energy produces a slowed-down absorption of the kinetic energy of the colliding vehicle. The shape and inner structure of the absorber body is not part of the present invention. The persons skilled in this art dispose of several variants for these bodies, all of them being compressed by the impact.

According to the simplest embodiment shown in FIG. 1 there exist only two absorber bodies located on either side of the central impact axis. On its side remote from the other body each absorber body is equipped with a saddleback like element 3 made of metal sheet whose top ridge 13 is aligned vertically and whose outer borders are provided with straps 12 located in corresponding slots at the border of the box 1. A vertical support member 8, for example a panel, is located along the top ridge between this ridge and the box and is also secured in position by means of straps 10, 11 engaged in slots of the box 1 and of the element 3 along the ridge. The sides of the saddleback-like element are provided with bent outwards borders 14 which are slanted towards the ridge.

This slanting guides a cable 2 in such a way that it runs along the ridge lines of both absorber bodies and urges them one against the other if the cable ends are unified under stress via an overload release element 15.

FIG. 2 shows schematically a top view of one box 1 with the saddleback-like element 3 and the cable 2. A spring 9 tends to draw the ridge of the element 3 and the support element 8 back into their initial positions if a central impact took place whose reduced energy did not release the overload release element 15.

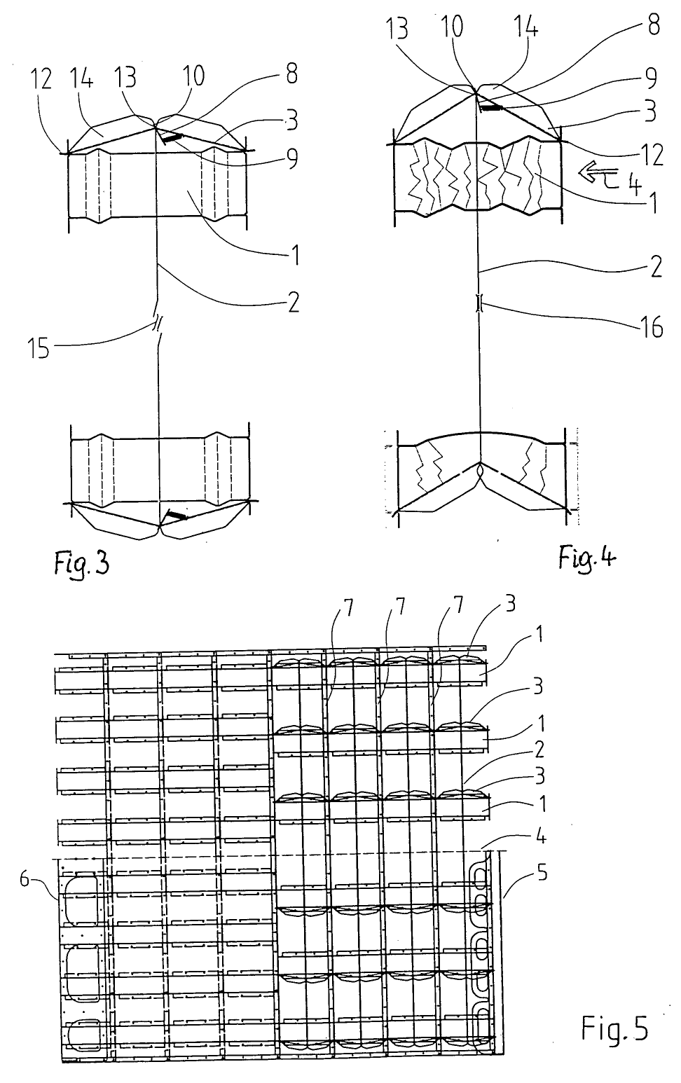

FIG. 3 shows the deformation of both absorber bodies due to a heavy but centralized impact along the arrow 4 in FIG. 1. The force vectors acting on each body 1 are directed in the drawing plane horizontally and affect both absorber bodies to the same extent. As a consequence, both bodies are compressed equally thereby increasing the distance between the two ridges. The stress of the cable 2 increases notably and the overload release device 15 opens the cable. Therefor the cable ceases to have effect on the further deformation of the boxes.

Completely different is the situation if the impact takes place eccentrically (arrow 4 in FIG. 4). If the cable were absent only the box on this side would become compressed and the impact plate 5 would give way to one side only. The vehicle would rebound also to the side, possibly into the close-by running traffic. Contrary thereto according to the invention, the lower absorber body of FIG. 4 is also deformed due to the fact that the increasing cable stress presses the support member 8 of this box via its preferably sharpened edge into the large and therefore easily deformable lateral side of the box. Thus, on the one hand, the deformation energy of this box which is not directly affected by the impact contributes to the transformation of the impact energy and, on the other hand, the inclination of the impact plate 5 is reduced or even completely avoided. Therefore the vehicle is not rebounded laterally.

The release threshold of the overload release device 15 is chosen in order to release only after a central impact of a given intensity, as described above in relation to FIG. 3.

The invention is not restricted to the embodiment described above: The steel cable could be replaced by other mechanical means such as a clamp between both elements 8 which releases if the force exceeds a given threshold.

Commonly a plurality of absorber bodies is used. In case of several absorber bodies aligned in one row a specific cable is provided for each pair of bodies. The bodies of each pair can be located symmetrically with respect to central line of the attenuation device. In this case the different pairs of absorber bodies are located at different distances, and; the cable of the pair having the greatest distance surrounds all the cables of absorber body pairs located closer to the central line of the device.

According to a preferred alternative embodiment, the distance between the bodies is the same for all the pairs and corresponds approximately to half the total width of the attenuator device. This simplifies the structure and enhances its efficiency, especially in case of a central impact, since in this case practically all the absorber bodies of a row are subjected to deformation.

If a vehicle impact attenuation device comprises several rows it is not necessary that in all the rows all the pairs of absorber bodies are contracted by cables. It is often sufficient to equip only the outermost absorber bodies or only the bodies of rows close to the impact plate with a support member 18 and the cable 2.

Moreover, the skilled person is aware that the saddleduck-like element 3 can be secured to the body not only by straps in slots. This element 3 and the support member 8 are preferably made from metal sheet, for example aluminium sheets.

It is well known that vehicles which collide with impact attenuation devices often catch fire if the impact destroys the fuel tank. If this happens in a tunnel not only the passengers in the impacting vehicle but, due to the smoke, numerous other traffic participants are in a life danger. In this case the impact attenuation devices according to the invention can act as “instant fire-brigade” if the absorber bodies are filled with a fire extinguishing product which is expelled automatically due to a heavy impact resulting in a deformation of the absorber bodies. In a multi-row arrangement of absorber bodies according to FIG. 5 this is particularly useful for the absorber bodies close to the impact plate 5. In order to concentrate the ejection of the liquid or powdery extinguishing product onto the fire centre the chambers containing this product should present at least one designed hole which opens due to an impact and which is disposed such that this product is expelled towards the impacting object.

The invention is not restricted to the embodiments described in detail but encompasses all variants covered by the definition of the main claim.

List of References

1 absorber body (box)
2 traction member (cable)
3 saddleback-like element
4 impact axis
5 impact plate
6 rear plate
7 intermediate plate
8 support member (support panel)
9 spring
10, 11, 12 straps
13 ridge
14 border
15 overload release element

1. A vehicle impact attenuator comprising at least two impact absorber bodies for transforming impact energy, which acts along a central impact axis, into deformation energy, the bodies being arranged in pairs, the bodies of each pair being located on either side of a central axis of the device, and being mechanically interconnected in such a way that the deformation of one of these bodies due to a crashing vehicle results in a deformation also of the other absorber body, induced by said mechanical interconnection.

2. Vehicle impact attenuation device according to claim 1, wherein the absorber bodies of at least one of said pairs are located at equal distance from the central impact axis of the device.

3. Vehicle impact attenuation device according to claim 1, wherein the absorber bodies (1) of at least one pair are located at different distances from the central impact axis of the device.

4. Vehicle impact attenuation device according to claim 3, wherein the distance between the impact absorber bodies of a pair is the same for all body pairs in a row and preferably corresponds to half the width dimension of the device.

5. Vehicle impact attenuation device having a plurality of absorber body (1) rows in series, wherein at least absorber bodies in rows close to the impact plate (5) are coupled in pairs as defined in claim 1.

6. Vehicle impact attenuation device according to claim 1, wherein each absorber body (1) of a pair is rigidly connected, at its side remote from the other body of the pair, to a saddleback-like element (3) whose top ridge (13) extends vertically and is supported by the respective body via a support member (8), and wherein a traction member (2) ensuring said mechanical coupling tends to approach the top ridges of the two bodies of a pair.

7. Vehicle impact attenuation device according to claim 6, wherein each traction member (2) comprises an overload release device (15).

8. Vehicle impact attenuation device according to claim 6, wherein the support member (8) is a support panel extending along the ridge line.

9. Vehicle impact attenuation device according to claim 8, wherein the support panel (8) is provided with a sharp edge in contact with the absorber body (1).

10. Vehicle impact attenuation device according to claim 6, wherein the traction member (2) consists of a cable extending along the ridge lines around the saddleback-like elements of a pair of absorber bodies (1).

11. Vehicle impact attenuation device according to any one of the preceding claims claim 1, wherein at least some of the absorber bodies contain a fire extinguishing product susceptible to be expelled by the effect of an impact.

12. Vehicle impact attenuation device according to claim 5, wherein at least the absorber bodies situated close to the impact plate (5) contain a fire extinguishing product.

13. Vehicle impact attenuation device according to claim 11, wherein chambers in the absorber bodies containing fire extinguishing products present at least one opening conceived to open due to an impact and disposed in order to expel the fire extinguishing product towards the impacting vehicle.

14. Vehicle impact attenuation device according to claim 11, wherein at least the absorber bodies situated close to the impact plate (5) contain a fire extinguishing product.

15. Vehicle impact attenuation device according to claim 12, wherein chambers in the absorber bodies containing fire extinguishing products present at least one opening conceived to open due to an impact and disposed in order to expel the fire extinguishing product towards the impacting vehicle.
